(19) United States
(12) Patent Application Publication
(10) Pub. No.: US 2026/0305629 A1
(43) Pub. Date: Oct. 8, 2026

(54) SMOKE GENERATING ASSEMBLY FOR A SMOKER

(71) Applicant: Haier US Appliance Solutions, Inc., Wilmington, DE (US)

(72) Inventors: Anna Fenko, Louisville, KY (US); Rocco J. Cordaro, Louisville, KY (US)

(21) Appl. No.: 19/170,482

(22) Filed: Apr. 4, 2025

(51) Int. Cl. A23B 4/052

(52) U.S. Cl. CPC A23B 4/0523

(57) ABSTRACT

A smoke generating assembly for a smoker. The smoker includes a smoking chamber positioned within a cabinet and a hopper for storing combustible material, the hopper defining a supply opening at a bottom of the hopper. The smoke generating assembly includes a belt feeder comprising a belt and extending between a first end and a second end, the first end being positioned below the supply opening of the hopper, a drive motor operably coupled to the belt feeder for selectively rotating the belt to advance the combustible material, and a smoldering heater positioned proximate the second end of the belt feeder for smoldering the combustible material as the belt advances the combustible material onto the smoldering heater.

### FIELD OF THE INVENTION

The present subject matter relates generally to smokers, and more particularly to smoke generating assemblies for smokers.

### BACKGROUND OF THE INVENTION

Conventional smokers include a smoking chamber and a firebox positioned within or fluidly coupled to the smoking chamber. The firebox is filled with a combustible material, such as wood or wood byproducts that are ignited or otherwise heated to generate smoke and/or heat. The heat and smoke are routed into the smoking chamber to impart flavor on and cook food items positioned within the smoking chamber. One or more heating elements may be positioned within the smoking chamber and the firebox to maintain the temperatures necessary both for cooking the food and for generating the desired amount of smoke.

Notably, some advanced conventional smokers include smoke generation systems that rely on burning combustible material, e.g., wood chunks, chips, or pellets. However, the conventional smoke generation systems include pellet delivery systems that deliver inconsistent quantities of pellets to the burn plate, leading to issues such as non-ignition, unburnt pellet waste, and frequent clogging. These problems arise at least in part from the system's inability to handle non-uniform pellet sizes, inconsistent pellet quality, and inadequate motor torque that causes auger jamming, resulting in no delivery of pellets to the burn plate. As a result, the smoker produces poor smoke flavor, low smoke output, and inconsistent cooking results, while the bulky design further limits space efficiency. The consumer has no indication of pellet delivery function and reliability.

Accordingly, a smoker that has features improving smoke regulation is desirable. More specifically, a smoker that includes a pellet distribution system or smoke generating assembly that improves the regulation of pellets and offers more precise control over the smoke generating process would be particularly beneficial.

Aspects and advantages of the invention will be set forth in part in the following description, may be apparent from the description, or may be learned through practice of the invention.

In one exemplary embodiment, a smoker defining a vertical direction, a lateral direction, and a transverse direction is provided, including a cabinet defining a discharge vent, a smoking chamber positioned within the cabinet and defining a chamber outlet, a hopper for storing combustible material, the hopper defining a supply opening at a bottom of the hopper, a smoke generating assembly for providing a flow of smoke into the smoking chamber. The smoke generating assembly includes a belt feeder comprising a belt and extending between a first end and a second end, the first end being positioned below the supply opening of the hopper, a drive motor operably coupled to the belt feeder for selectively rotating the belt to advance the combustible material, and a smoldering heater positioned proximate the second end of the belt feeder for smoldering the combustible material as the belt advances the combustible material onto the smoldering heater.

In another exemplary embodiment, a smoke generating assembly for a smoker is provided. The smoker includes a smoking chamber positioned within a cabinet and a hopper for storing combustible material, the hopper defining a supply opening at a bottom of the hopper. The smoke generating assembly includes a belt feeder comprising a belt and extending between a first end and a second end, the first end being positioned below the supply opening of the hopper, a drive motor operably coupled to the belt feeder for selectively rotating the belt to advance the combustible material, and a smoldering heater positioned proximate the second end of the belt feeder for smoldering the combustible material as the belt advances the combustible material onto the smoldering heater.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an indoor smoker with a door in a closed position in accordance with an example embodiment of the present disclosure.

FIG. 2 provides a perspective view the example indoor smoker of FIG. 1 with the door opened.

FIG. 3 provides a partial perspective view of the example indoor smoker of FIG. 1 according to an example embodiment of the present subject matter.

FIG. 4 is a front cross-sectional view of the example indoor smoker of FIG. 1 according to an example embodiment of the present subject matter.

FIG. 5 is a side cross-sectional view of the example indoor smoker of FIG. 1 according to an example embodiment of the present subject matter.

FIG. 6 provides another partial perspective view of the example indoor smoker of FIG. 1 according to an example embodiment of the present subject matter.

FIG. 7 provides another partial perspective view of the example indoor smoker of FIG. 1 according to an example embodiment of the present subject matter.

FIG. 8 provides a side, schematic view of a belt feeder of the example indoor smoker of FIG. 1 according to an example embodiment of the present subject matter.

FIG. 9 provides a top, schematic view of the example belt feeder of FIG. 8 according to an example embodiment of the present subject matter.

FIG. 10 provides a side, schematic view of a belt feeder of the example indoor smoker of FIG. 1 according to an example embodiment of the present subject matter.

FIG. 11 provides a side, schematic view of a belt feeder of the example indoor smoker of FIG. 1 according to an example embodiment of the present subject matter.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

As explained herein, aspects of the present subject matter are generally directed to a belt feeder system or belt conveyor system that provides an additional surface for pellets to be spaced out and widens clearance in the delivery system to prevent clogging. The belt feeder system may be attached to a motor or powered device such as a solid shaft, belt drive, or gear train. Fins or spacers may be attached to the belt system to separate a consistent quantity of pellets spaced out over the belt surface area. The fins or spacers may also act as a ramp that allows the pellets to be transferred onto the burn plate. The belt feeder may lie flat or at a slight angle allowing gravity to help the pellets transfer down the ramp onto the burn plate. A gap/opening between the pellet shoot and belt feeder may limit the size and quantity of pellets in a specific section. This also limits pellets from sitting on top of one another.

An actuator, solenoid, or other software-controlled mechanism may control and limit the quantity of pellets being delivered to the pellet feeder system. The pellets may be stored in the pellet shoot, stopped at the opening surface of the movable part. A set sequence predetermined to be in sync with the feeder system may be programmed to trigger the mechanism to open and close at a set interval to allow the dispersion of a set quantity of pellets to the feeder system. Then, the feeder system delivers the pellets to the burn plate. According to an example embodiment, another dispenser mechanism, such as a rotary feed mechanism, may be provided at the bottom opening of the pellet shoot to control and limit the quantity of pellets being delivered to the pellet feeder system.

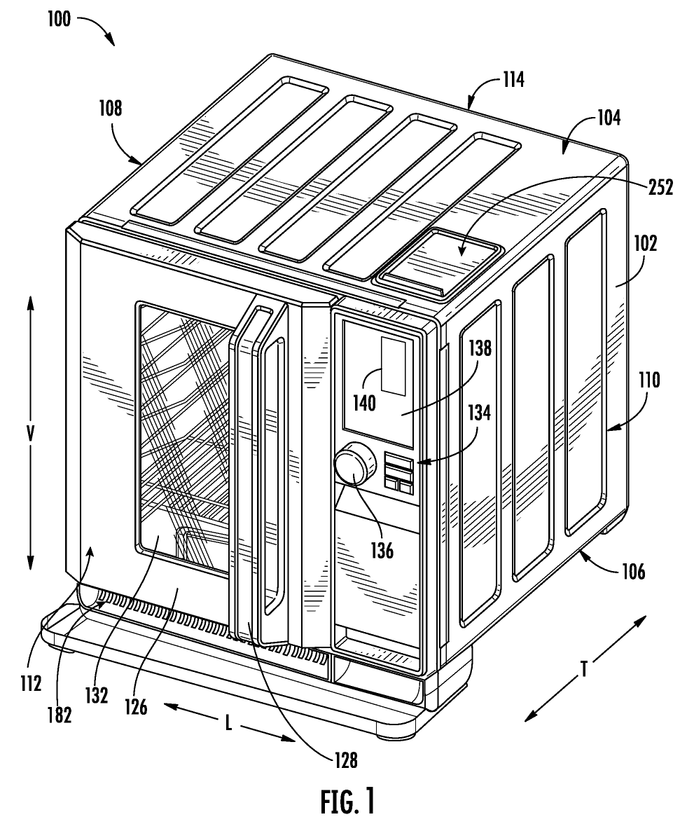

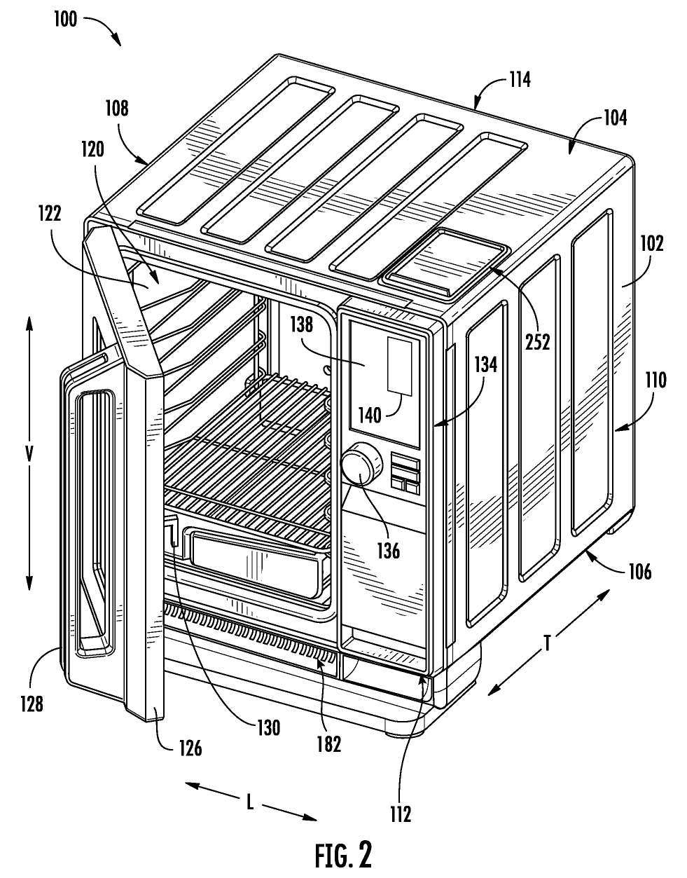

FIGS. 1 and 2 provide perspective views of an indoor smoker 100 according to an exemplary embodiment of the present subject matter with the door in the closed position and the open position, respectively. Indoor smoker 100 generally defines a vertical direction V, a lateral direction L, and a transverse direction T, each of which is mutually perpendicular, such that an orthogonal coordinate system is generally defined. As illustrated, indoor smoker 100 includes an insulated cabinet 102. Cabinet 102 of indoor smoker 100 extends between a top 104 and a bottom 106 along the vertical direction V, between a first side 108 (left side when viewed from front) and a second side 110 (right side when viewed from front) along the lateral direction L, and between a front 112 and a rear 114 along the transverse direction T.

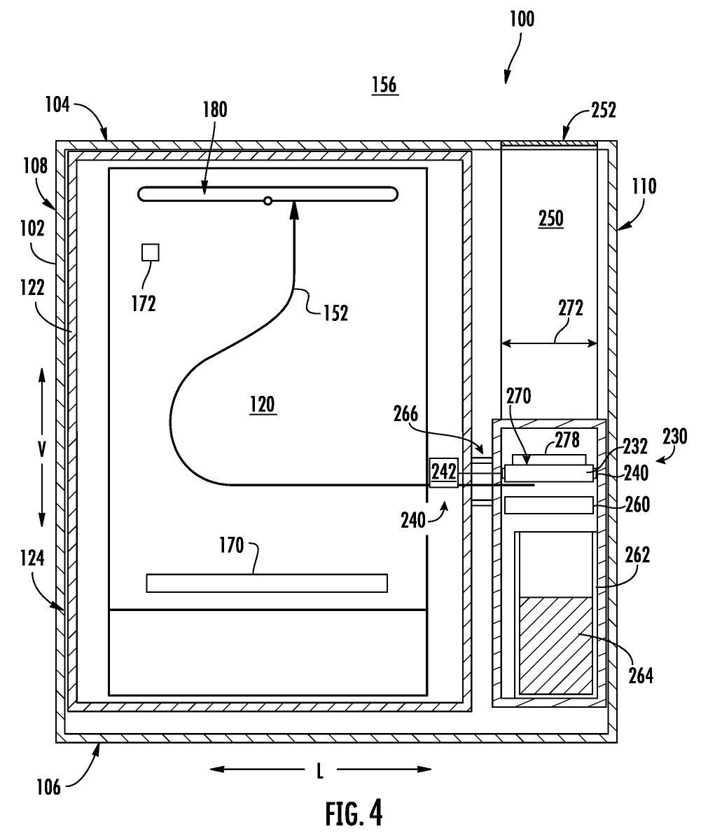

Within cabinet 102 is a smoking chamber 120 which is configured for the receipt of one or more food items to be cooked and/or smoked. In general, smoking chamber 120 is at least partially defined by a plurality of chamber walls 122. Specifically, smoking chamber 120 may be defined by a top wall, a rear wall, a bottom wall, and two sidewalls. These chamber walls 122 may define smoking chamber 120 and an opening through which a user may access food articles placed therein. In addition, chamber walls 122 may be joined, sealed, and insulated to help retain smoke and heat within smoking chamber 120. In this regard, for example, in order to insulate smoking chamber 120, indoor smoker 100 includes an insulation gap 124 (FIG. 4) defined between chamber walls 122 and cabinet 102. According to an exemplary embodiment, insulation gap 124 is filled with insulating material (not shown), such as insulating foam or fiberglass.

Indoor smoker 100 includes a door 126 rotatably attached to cabinet 102 in order to permit selective access to smoking chamber 120. A handle 128 is mounted to door 126 to assist a user with opening and closing door 126 and a latch 130 (FIG. 2) is mounted to cabinet 102 for locking door 126 in the closed position during a cooking or smoking operation. In addition, door 126 may include one or more transparent viewing windows 132 to provide for viewing the contents of smoking chamber 120 when door 126 is closed and also to assist with insulating smoking chamber 120.

Referring still to FIGS. 1 and 2, a user interface panel 134 and a user input device 136 may be positioned on an exterior of cabinet 102. User interface panel 134 may represent a general purpose Input/Output ("GPIO") device or functional block. In some embodiments, user interface panel 134 may include or be in operative communication with user input device 136, such as one or more of a variety of digital, analog, electrical, mechanical or electro-mechanical input devices including rotary dials, control knobs, push buttons, and touch pads. User input device 136 is generally positioned proximate to user interface panel 134, and in some embodiments, user input device 136 may be positioned on user interface panel 134. User interface panel 134 may include a display component 138, such as a digital or analog display device designed to provide operational feedback to a user.

Generally, indoor smoker 100 may include a controller 140 in operative communication with user input device 136. User interface panel 134 of indoor smoker 100 may be in communication with controller 140 via, for example, one or more signal lines or shared communication busses, and signals generated in controller 140 operate indoor smoker 100 in response to user input via user input devices 136. Input/Output ("I/O") signals may be routed between controller 140 and various operational components of indoor smoker 100 such that operation of indoor smoker 100 can be regulated by controller 140.

Controller 140 is a “processing device” or “controller” and may be embodied as described herein. Controller 140 may include a memory and one or more microprocessors, microcontrollers, application-specific integrated circuits (ASICS), CPUs or the like, such as general or special purpose microprocessors operable to execute programming instructions or micro-control code associated with operation of indoor smoker 100, and controller 140 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 140 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Although aspects of the present subject matter are described herein in the context of an indoor smoker having a single smoking chamber, it should be appreciated that indoor smoker 100 is provided by way of example only. Other smoking appliances having different configurations, different appearances, and/or different features may also be utilized with the present subject matter, e.g., outdoor smokers, conventional oven appliances, or other suitable cooking appliances. Thus, the example embodiment shown in FIG. 1 is not intended to limit the present subject matter to any particular smoking configuration or arrangement. Moreover, aspects of the present subject matter may be used in any other consumer or commercial appliance.

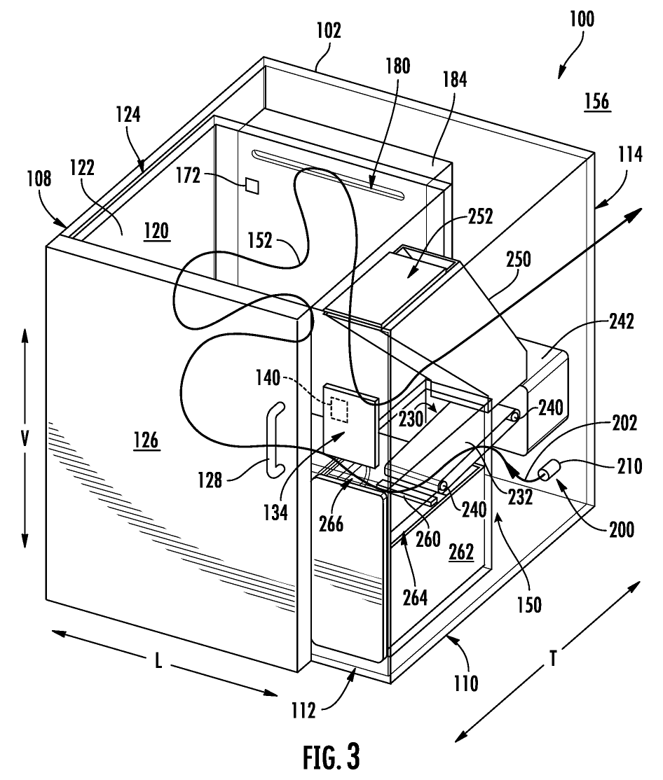

Referring now also to FIG. 3, various internal components of an indoor smoker 100 and their respective functions will be described according to an exemplary embodiment of the present subject matter. In this regard, FIG. 3 illustrates a partial perspective view of an indoor smoker 100 similar to that shown in FIG. 1. As shown, indoor smoker 100 generally includes smoking chamber 120 for receiving items to be cooked/smoked, a smoke generating device or smoke generating assembly 150 for generating a flow of smoke (indicated by reference numeral 152 in FIG. 3), and an exhaust system 154 for safely discharging that the air and/or smoke into an indoor environment 156 (i.e., outside of indoor smoker 100). Each of these systems and components will be described in detail below.

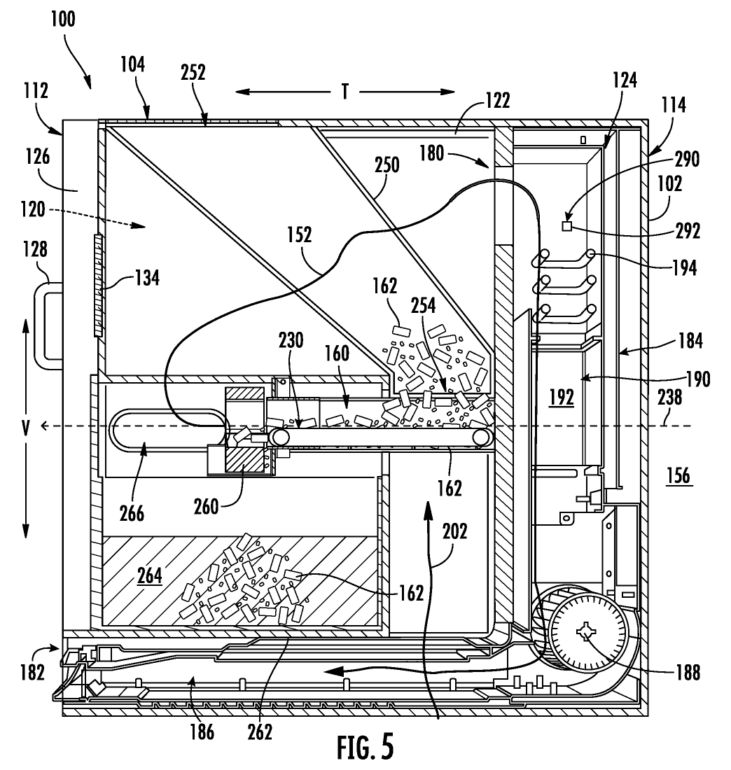

Referring to FIG. 5, smoke generating assembly 150 generally defines a smoldering chamber 160 which is configured for receiving combustible material 162. As used herein, “combustible material” is generally used to refer to any suitable material positioned within smoldering chamber 160 for generating smoke. Specifically, according to exemplary embodiments, combustible material 162 includes wood or wood byproducts, such as wood chunks, wood chips, wood pellets, or wood resin. According to the exemplary embodiment, smoke generating assembly 150 may include a door or another access panel (not shown) for providing selective access to smoldering chamber 160, e.g., to add additional combustible material 162.

As best shown in FIG. 4, in order to ensure a desirable cooking temperature within smoking chamber 120, indoor smoker 100 further includes a chamber heater 170 that is positioned within or otherwise in thermal communication with smoking chamber 120 for regulating the temperature in smoking chamber 120. In general, chamber heater 170 may include one or more heating elements positioned within cabinet 102 for selectively heating smoking chamber 120. For example, the heating elements may be electric resistance heating elements, gas burners, microwave heating elements, halogen heating elements, or suitable combinations thereof. Notably, because chamber heater 170 is operated independently of smoke generating assembly 150 (e.g., as described below), smoking chamber 120 may be maintained at any suitable temperature during a smoking process. More specifically, for example, chamber heater 170 may be turned off or on a very low setting for smoking cheeses or may be turned on high for quickly cooking and smoking meats.

In some embodiments, indoor smoker 100 also includes one or more sensors that may be used to facilitate improved operation of the appliance, such as described below. For example, indoor smoker 100 may include one or more temperature sensors which are generally operable to measure the internal temperature in indoor smoker 100, e.g., within smoking chamber 120 and/or smoldering chamber 160. More specifically, as illustrated, indoor smoker 100 includes a temperature sensor 172 positioned within smoking chamber 120 and being operably coupled to controller 140. In some embodiments, controller 140 is configured to vary operation of chamber heater 170 based on one or more temperatures detected by temperature sensor 172.

As described herein, “temperature sensor” may refer to any suitable type of temperature sensor. For example, the temperature sensors may be thermocouples, thermistors, or resistance temperature detectors. In addition, temperature sensor 172 may be mounted at any suitable location and in any suitable manner for obtaining a desired temperature measurement, either directly or indirectly. Although exemplary positioning of certain sensors is described below, it should be appreciated that indoor smoker 100 may include any other suitable number, type, and position of temperature sensors according to alternative embodiments.

As mentioned briefly above, indoor smoker 100 further includes an exhaust system 154 which is generally configured for safely discharging the flow of smoke 152 from indoor smoker 100. Specifically, according to the illustrated embodiment, exhaust system 154 generally extends between a chamber outlet 180 and a discharge vent 182 defined by cabinet 102 for directing the flow of smoke 152 from smoking chamber 120 to the environment 156. Although an exemplary exhaust system 154 is described below, it should be appreciated that variations and modifications may be made while remaining within the scope of the present subject matter. For example, the routing of ducts, the catalytic converter arrangement, and the types of sensors used may vary according to alternative embodiments. For example, although discharge vent 182 is illustrated as being defined proximate a bottom and front of cabinet 102, other suitable positions of discharge vent 182 and routing of the exhaust are possible and within the scope of the present subject matter.

As shown, exhaust system 154 includes an exhaust duct 184 and a discharge duct 186 that generally extend between and provides fluid communication between chamber outlet 180 and discharge vent 182. In this regard, according to the illustrated embodiment, exhaust duct 184 may generally extend between chamber outlet 180 and an air handler 188 (e.g., upstream of air handler 188), while discharge duct 186 may generally extend between air handler 188 and discharge vent 182 (e.g., downstream of air handler 188). According to the illustrated embodiment, discharge vent 182 is defined at a bottom 106, front 112 side of insulated cabinet 102 and discharge duct 186 is a substantially rectangular plenum that extends within a horizontal plane (e.g., defined by the lateral direction L and the transverse direction T). However, it should be appreciated that duct configurations may vary while remaining within the scope of the present subject matter.

Indoor smoker 100 further includes air handler 188 that is operably coupled with exhaust duct 184 and discharge duct 186 for facilitating the smoldering process and smoke generating process. For example, air handler 188 draws the flow of smoke 152 through exhaust duct 184 and discharges the flow of smoke 152 through discharge duct 186 and out of discharge vent 182 to environment 156. According to the illustrated exemplary embodiment, air handler 188 is a centrifugal fan positioned within exhaust duct 184. However, it should be appreciated that according to alternative embodiments, air handler 188 may be positioned at any other suitable location and may be any other suitable fan type, such as a tangential fan, an axial fan, etc.

In addition, according to an exemplary embodiment, air handler 188 is a variable speed fan such that it may rotate at different rotational speeds, thereby generating different air flow rates. In this manner, the amount of smoke drawn from smoldering chamber 160 may be continuously and precisely regulated. Moreover, by pulsing the operation of air handler 188 or throttling air handler 188 between different rotational speeds, the flow of smoke 152 drawn into smoking chamber 120 may enter from a different direction, may have a different flow velocity, or may generate a different flow pattern within smoking chamber 120. Thus, by pulsating the variable speed fan or otherwise varying its speed, the flow of smoke 152 may be randomized, thereby eliminating stagnant regions within smoking chamber 120 and better circulating the flow of smoke 152 to provide a more even cooking/smoking profile.

As illustrated, indoor smoker 100 further includes a catalytic converter 190 which is positioned within exhaust duct 184 for lowering or removing volatile organic compounds (VOCs) from the flow of smoke 152. As used herein, “catalytic converter” or variations thereof may be used to refer to any component, machine, or device that is configured for removing or lowering volatile organic compounds (VOCs), toxic gases, harmful emissions, pollutants, or undesirable compounds from a flow of air and smoke. For example, according to the illustrated embodiment, catalytic converter 190 generally includes a catalytic element 192 and a catalyst heater 194. Although catalytic converter 190 is illustrated herein as being positioned within exhaust duct 184, it should be appreciated that according to other embodiments catalytic converter 190 be positioned at any other suitable location, so long as catalytic converter 190 is inline with the flow of smoke 152, such that volatile organic compounds may be reduced.

In general, catalytic element 192 includes a material that causes an oxidation and a reduction reaction. For example, precious metals such as platinum, palladium, and rhodium are commonly used as catalyst materials, though other catalysts are possible and within the scope of the present subject matter. In operation, the catalytic element 192 may combine oxygen (O₂) with carbon monoxide (CO) and unburned hydrocarbons to produce carbon dioxide (CO₂) and water (H₂O). In addition, according to exemplary embodiments, catalytic element 192 may remove nitric oxide (NO) and nitrogen dioxide (NO₂). According to example embodiments, catalytic element 192 may have a base made of metal, ceramic, or any other suitable material.

Notably, catalytic converters typically require that the catalyst be heated to a suitably high temperature in order to catalyze the necessary chemical reactions. Therefore, catalyst heater 194 is in thermal communication with catalytic element 192 for heating it to a suitable temperature, such as approximately 800° F. According to the illustrated embodiment, catalyst heater 194 is positioned upstream of catalytic element 192 to provide thermal energy through convection. However, it should be appreciated that according to alternative embodiments, catalyst heater 194 may be in direct contact with catalytic element 192 to provide thermal energy through conduction, or may be thermally coupled to catalytic element 192 in any other suitable manner. In order to ensure a catalyst temperature of catalytic element 192 remains above a temperature suitable for controlling emissions, indoor smoker 100 may further include a catalyst temperature sensor (not shown) that may be monitored by controller 140.

Referring still to FIG. 5, the construction and operation of smoke generating assembly 150 will be described in more detail according to an exemplary embodiment of the present subject matter. As illustrated, indoor smoker 100 defines an air inlet 200 for receiving air to support the combustion or smoldering process. Specifically, air inlet 200 is configured for receiving a flow of combustion air (indicated by reference numeral 202 in FIG. 5) from the ambient environment 156 surrounding indoor smoker 100 or from another air supply source. During a smoking process, combustible material 162 is ignited and the flow of combustion air 202 supports the smoldering process to generate the flow of smoke 152. Smoke generating assembly 150 further defines a smoke outlet for providing a flow of smoke 152 into smoking chamber 120 during a smoking operation, as will be described in detail below.

In addition, indoor smoker 100 may further include features for preventing or regulating the flow of combustion air 202 from entering indoor smoker 100 from environment 156 when the flow of such air is not desired. In this regard, for example, indoor smoker 100 may include an inlet check valve 210 which is operably coupled to air inlet 200. In general, this check valve prevents the flow of combustion air 202 from entering smoldering chamber 160 when not desired. For example, inlet check valve 210 may have a “cracking pressure,” which is used herein to refer to the pressure, or more precisely the negative pressure, required within smoldering chamber 160 to open inlet check valve 210. In this manner, inlet check valve 210 may be designed to permit the flow of combustion air 202 only when air handler 188 is operating and urging air through smoldering chamber 160, thus facilitating the quick and effective asphyxiation of combustible material 162 within smoldering chamber 160 when desired.

According to the illustrated embodiment, smoke generating assembly 150 generally includes a belt feeder 230 that includes a belt 232 for transporting combustible material 162, as described in more detail below. In general, belt feeder 230 extends between a first end 234 and a second end 236 substantially along a feed direction 238. Specifically, as illustrated, feed direction 238 extends substantially within a horizontal plane within cabinet 102, e.g., directly along the transverse direction T or at a slight angle. In general, belt feeder 230 is configured for receiving the combustible material 162 and facilitating a smoldering process.

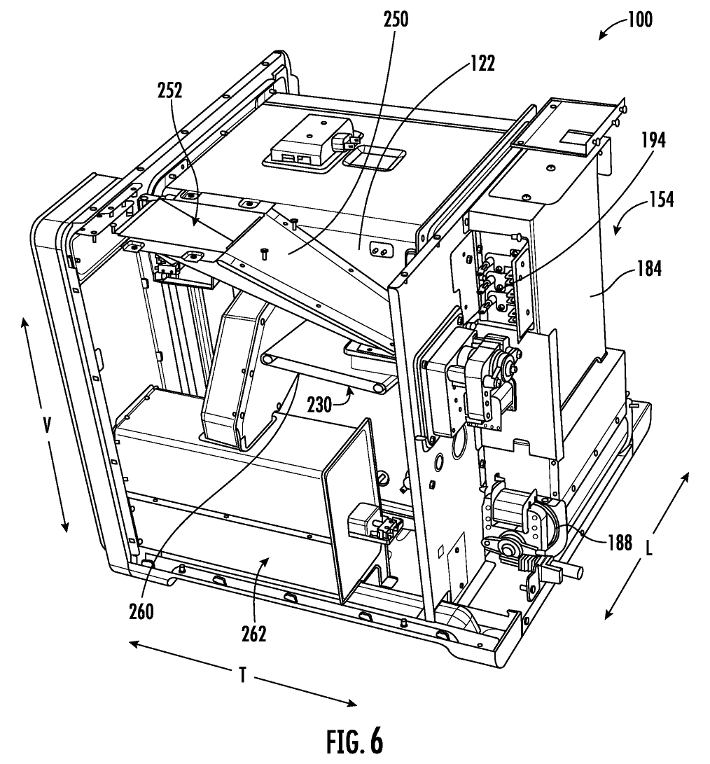

As shown, belt feeder 230 may include a plurality of rotating cylinders 240 and belt 232 may be wrapped around rotating cylinders 240. In addition, at least one of the plurality of rotating cylinders 240 may be mechanically coupled to a drive mechanism 242. According to an example embodiment, such as illustrated in FIG. 6, drive mechanism 242 may include a drive motor 244 that is directly coupled to one of the rotating cylinders 240, e.g., through direct coupling of an output shaft of drive motor 244. As used herein, “motor” may refer to any suitable drive motor and/or transmission assembly for driving belt feeder 230. For example, the drive motor may be a brushless DC electric motor, a stepper motor, or any other suitable type or configuration of motor. For example, the drive motor may be an AC motor, an induction motor, a permanent magnet synchronous motor, or any other suitable type of AC motor. In addition, the drive motor and the transmission assembly may include any suitable motor or transmission sub-assemblies, clutch mechanisms, or other components.

It should be appreciated that other means of coupling drive mechanism 242 to belt feeder 230 are possible and within the scope of the present subject matter. For example, according to alternative embodiments, such as illustrated in FIG. 9, drive mechanism 242 may include drive motor 244 and a gearing arrangement 246 to mechanically couple drive motor 244 to one of the rotating cylinders 240. According to still other embodiments, drive mechanism 242 may include a belt drive arrangement or any other suitable mechanism for rotating one or more of rotating cylinders 240, e.g., thereby selectively advancing belt 232 under commands from controller 140.

As illustrated, smoke generating assembly 150 may further include a hopper 250 that is generally configured for storing and selectively depositing combustible material 162 onto belt feeder 230. More specifically, as illustrated, hopper 250 may be a large, tapered reservoir with a top opening 252 positioned at top 104 of cabinet 102. A user may fill hopper 250 by pouring or providing combustible material 162 into hopper 250 through top opening 252. Hopper 250 may taper toward a supply opening 254 positioned at a bottom 256 of hopper 250. As shown, supply opening 254 is positioned above first end 234 of belt feeder 230, e.g., such that combustible material 162 is deposited directly from hopper 250 onto belt 232 at first end 234. Once combustible material 162 is deposited on belt 232, drive mechanism 242 may operate the rotating cylinders 240 to advance the combustible material 162 along the feed direction 238.

Smoke generating assembly 150 further includes one or more smoldering heaters 260 which are positioned proximate second end 236 of belt feeder 230. According to an exemplary embodiment, smoldering heater 260 may include one or more cartridge heaters or silicon nitride igniters. Alternatively, smoldering heater 260 may include any other suitable type, position, and configuration of heating elements. As used herein, the term “heating element,” “heaters,” and the like may generally refer to electric resistance heating elements, gas burners, microwave heating elements, halogen heating elements, or suitable combinations thereof. For example, smoldering heater 260 may be a heated plate that is approximately the same width as belt 232.

As used herein, the verb “smolder” or variations thereof is intended to refer to burning a combustible material (e.g., combustible material 162) slowly such that smoke is generated but little or no flame is generated. In this manner, the combustible material is not expended quickly, but a large amount of smoke is generated for the smoking process. Notably, the burn rate of combustible material and the amount of smoke generated is regulated using smoldering heater 260. For typical combustible material used in smokers, e.g., wood and wood byproducts, a typical smoldering temperature is between about 650° F and 750° F. However, the exact temperature may vary depending on the combustible material used, the air flow rate through smoldering chamber 160, the level of combustible material 162, and other factors.

According to the exemplary illustrated embodiment, smoldering heater 260 is positioned proximate second end 236 of belt feeder 230. In this manner, as belt feeder 230 is operated and belt 232 advances, combustible material 162 positioned on belt 232 will be deposited onto smoldering heater 260. After combustible material 162 positioned near smoldering heater 260 is consumed or smoldered, belt 232 may be advanced such that fresh combustible material 162 pushes the consumed combustible material 162 off of smoldering heater 260.

According to an exemplary embodiment, a water extinguishing assembly 262 may be configured for receiving consumed combustible material 162 when discharged from smoke generating assembly 150. In this regard, for example, water extinguishing assembly 262 may be positioned directly below belt feeder 230 and/or smoldering heater 260 such that used combustible material 162 may fall therein and immediately extinguish. For example, according to the illustrated embodiment, water extinguishing assembly 262 is filled with water 264 to immediately extinguish combustible material 162 when dropped into water extinguishing assembly 262. However, it should be appreciated that other liquids or materials for extinguishing combustible material 162 may be contained within water extinguishing assembly 262.

Notably, it may be desirable to ensure even distribution of combustible material 162, e.g., wood pellets, along a top surface 270 of belt feeder 230. Accordingly, supply opening 254 of hopper 250 may define an opening width 272 and belt 232 may define a belt width 274. According to an example embodiment, belt width 274 may be equal to or greater than opening width 272. For example, opening width 272 may be large enough to distribute and even layer of combustible material 162 over an entire width or section of belt 232. In addition, a clearance gap 276 may be defined between bottom 256 of hopper 250 and top surface 270 of belt feeder 230. In this manner, clearance gap 276 may be sized such that bottom 256 of hopper 250 spreads the combustible material 162 on belt 232 in a single, even layer as belt 232 advances the combustible material 162.

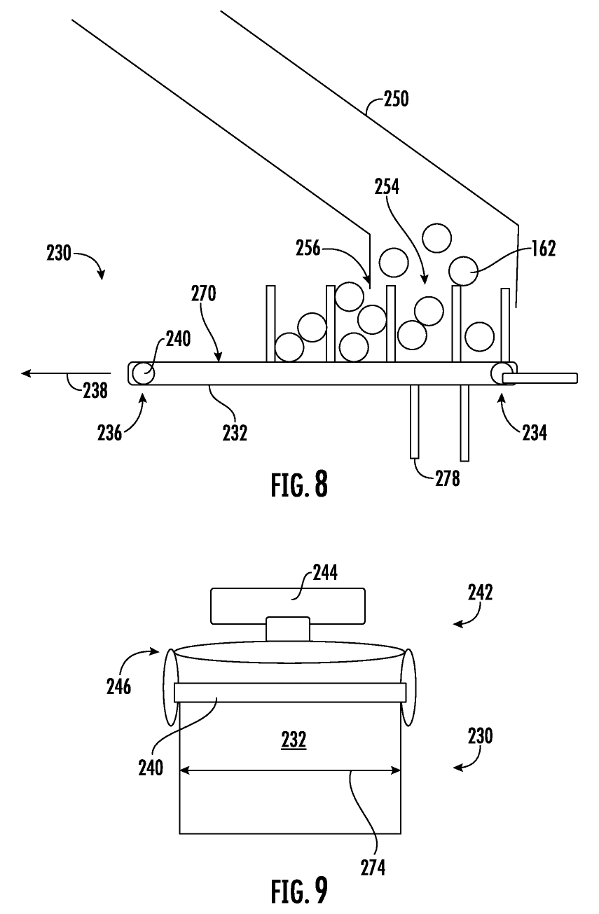

In addition, as best shown in FIG. 8, belt feeder 230 may include a plurality of fins 278 that extend along belt width 274 of belt 232 and which are spaced apart along a length of belt 232, e.g., along the feed direction 238. According to an example embodiment, fins 278 are formed from a resilient material and are designed to help sort or compartmentalize combustible material 162 as it exits supply opening 254. According to an example embodiment, clearance gap 276 may be greater than or equal to a height of fins 278. According to alternative embodiments, fins 278 may be sized to deflect slightly as they move past bottom 256 of hopper 250.

According to the illustrated embodiment, belt 232 is maintained in a level orientation within a horizontal plane (e.g., defined by the lateral direction L and the transverse direction T). By contrast, belt 232 may be angled downward toward smoldering heater 260 to help facilitate movement of the combustible material under the force of gravity. Once a load of combustible material 162 travels to second end 236 of belt feeder 230, fins 278 may exit the vertical orientation as belt 232 wraps around rotating cylinder 240. In this manner, fins 278 may act as a ramp to neatly drop the load of combustible material 162 onto smoldering heater 260. In addition, fins 278 may be designed to contact smoldering heater 260 as they are advanced past smoldering heater 260. In this manner, a bottom side of fins 278 act to wipe consumed combustible material 162 off of smoldering heater 260 while simultaneously depositing a fresh batch of combustible material 162.

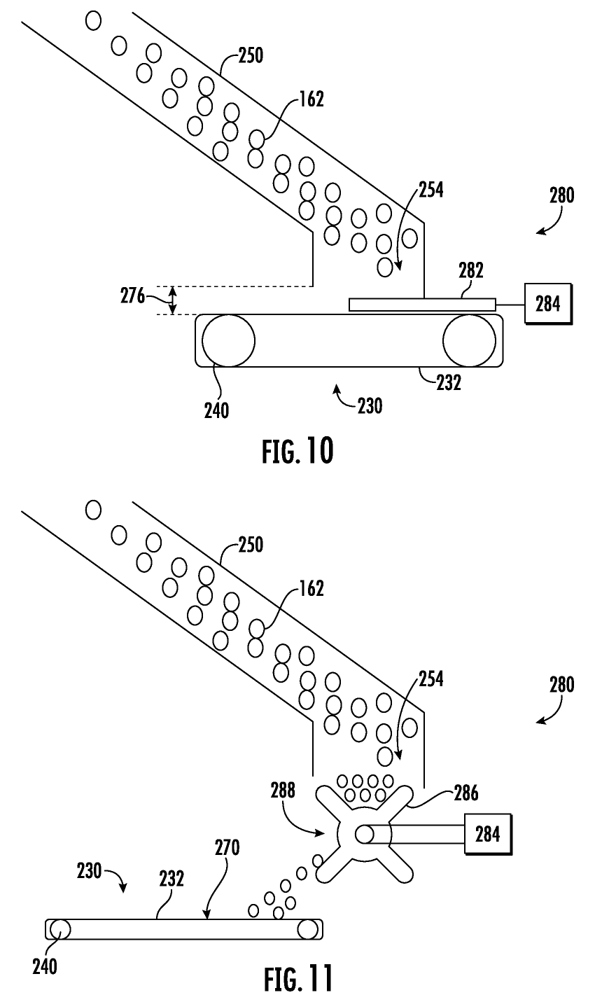

Referring now specifically to FIGS. 10 and 11, smoke generating assembly 150 may further include a pellet regulation device 280 that is positioned over supply opening 254 of hopper 250 for regulating distribution of combustible material 162. In this regard, pellet regulation device 280 may include any suitable devices or mechanisms for closing, opening, or partially opening supply opening 254 to permit combustible material 162 to fall onto belt 232. For example, as illustrated in FIG. 10, pellet regulation device 280 is a door 282 driven by an actuator 284. The actuator 284 may selectively position door 280 to adjust the deposition of combustible material 162. According to the example embodiment illustrated in FIG. 11, pellet regulation device 280 is a rotary feed mechanism 286 having a plurality of pellet chambers 288. An upper pellet chamber 288 is filled with a predetermined amount of combustible material 162, and rotating the rotary feed mechanism 286 dumps the combustible material 162 onto belt 232 while simultaneously filling the next pellet chamber 288.

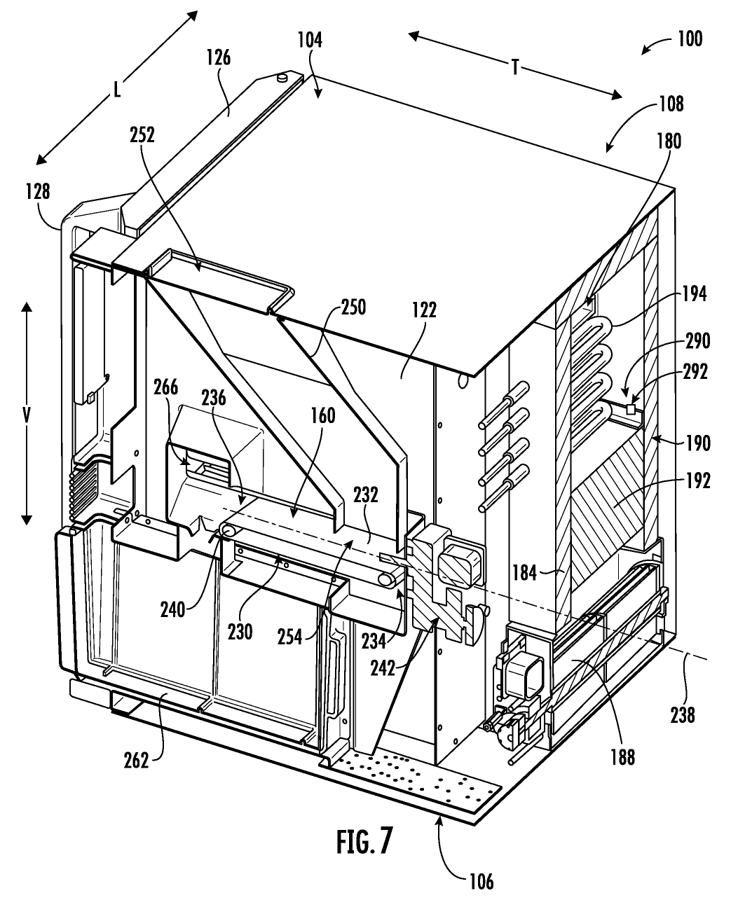

Referring now generally to FIGS. 5 and 7, indoor smoker 100 may further include an air quality monitoring system 290 that is generally configured to monitor the quality of the flow of smoke 152 passing through exhaust system 154. For example, air quality monitoring system 290 may be operably coupled to or positioned within exhaust duct 184 for monitoring the flow of smoke 152 and the operation of catalytic converter 190. In general, controller 140 (or another suitable controller) may be in operative communication with air quality monitoring system 290 and other components of indoor smoker 100 for operating indoor smoker 100 and implementing one or more steps of the methods described herein.

According to example embodiments of the present subject matter, air quality monitoring system 290 may include one or more air quality sensors (identified herein generally by reference numeral 292) that are configured for monitoring the flow of smoke 152. For example, air quality sensors 292 may be positioned and configured for providing data related to any suitable qualitative or quantitative condition of the flow of smoke 152. For example, air quality sensors 292 may include sensors for measuring at least one of carbon monoxide, formaldehyde, or other volatile organic compounds (VOCs). These air quality sensors 292 may provide feedback regarding VOCs to controller 140 in any suitable manner and in any suitable unit of measure, e.g., such as total volume, parts per million (ppm), etc. According to still other embodiments, air quality sensors 292 may include one or more optical sensors for detecting particulate matter within the flow of smoke 152.

In addition, it should be appreciated that air quality sensors 292 may be positioned at any suitable location for monitoring the flow of smoke 152. For example, according to an example embodiment, air quality monitoring system 290 may include a single air quality sensor 292 positioned downstream of catalytic element 192. In this regard, for example, air quality sensor 292 may be positioned between catalytic element 192 and air handler 188 within exhaust duct 184. In this manner, the air quality may be sensed immediately downstream of catalytic element 192 for improved measurement precision. According to still other embodiments, air quality sensor 292 may be positioned downstream of air handler 188, e.g., within discharge vent 182. According to still other embodiments, air quality sensor 292 may be positioned within the room where indoor smoker 100 is located and may be directly wired to controller 140 or configured for communicating wirelessly with controller 140.

According to example embodiments, air quality sensor 292 may be a smoke sensor intended to measure a quantity of smoke within smoking chamber 120. In this regard, air quality sensor 292 may be a silicon-controlled rectifier for monitoring smoke quantity and/or quality, though other suitable sensors may be used according to alternative embodiments. In general, a user may receive feedback from the smoke sensor and may manipulate the operation of indoor smoker to regulate the smoke quality/quantity as desired to achieve the desired level of smokiness within smoking chamber 120.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A smoker defining a vertical direction, a lateral direction, and a transverse direction, the smoker comprising:
a cabinet defining a discharge vent;
a smoking chamber positioned within the cabinet and defining a chamber outlet;
a hopper for storing combustible material, the hopper defining a supply opening at a bottom of the hopper;
a smoke generating assembly for providing a flow of smoke into the smoking chamber, the smoke generating assembly comprising:
a belt feeder comprising a belt and extending between a first end and a second end, the first end being positioned below the supply opening of the hopper;
a drive motor operably coupled to the belt feeder for selectively rotating the belt to advance the combustible material; and
a smoldering heater positioned proximate the second end of the belt feeder for smoldering the combustible material as the belt advances the combustible material onto the smoldering heater.

2. The smoker of claim 1, wherein the supply opening defines an opening width and the belt defines a belt width, the belt width being equal to or greater than the opening width.

3. The smoker of claim 1, wherein the belt feeder further comprises:
a plurality of fins extending along a belt width of the belt and spaced apart along a length of the belt.

4. The smoker of claim 3, wherein the plurality of fins are formed from a resilient material.

5. The smoker of claim 3, wherein the plurality of fins contact the smoldering heater when advanced past the smoldering heater.

6. The smoker of claim 1, wherein a clearance gap is defined between the bottom of the hopper and a top surface of the belt feeder, the clearance gap being sized such that the bottom of the hopper spreads the combustible material on the belt in a single layer.

7. The smoker of claim 6, wherein the clearance gap is greater than or equal to a height of a plurality of fins extending from the belt.

8. The smoker of claim 1, wherein the belt is level within a horizontal plane.

9. The smoker of claim 1, wherein the belt is angled downward toward the smoldering heater.

10. The smoker of claim 1, wherein the belt feeder further comprises:
a plurality of rotating cylinders, the belt being wrapped around the plurality of rotating cylinders, wherein at least one of the plurality of rotating cylinders is mechanically coupled to the drive motor.

11. The smoker of claim 10, wherein the at least one of the plurality of rotating cylinders is mechanically coupled to the drive motor through a belt drive, a gear drive, or directly through a drive shaft.

12. The smoker of claim 1, wherein the smoke generating assembly further comprises:
a pellet regulation device positioned over the supply opening of the hopper for regulating distribution of the combustible material.

13. The smoker of claim 12, wherein the pellet regulation device is a door driven by an actuator between an open position and a closed position.

14. The smoker of claim 12, wherein the pellet regulation device is a rotary feed mechanism having a plurality of pellet chambers.

15. A smoke generating assembly for a smoker, the smoker comprising a smoking chamber positioned within a cabinet and a hopper for storing combustible material, the hopper defining a supply opening at a bottom of the hopper, the smoke generating assembly comprising:
a belt feeder comprising a belt and extending between a first end and a second end, the first end being positioned below the supply opening of the hopper;
a drive motor operably coupled to the belt feeder for selectively rotating the belt to advance the combustible material; and
a smoldering heater positioned proximate the second end of the belt feeder for smoldering the combustible material as the belt advances the combustible material onto the smoldering heater.

16. The smoke generating assembly of claim 15, wherein the supply opening defines an opening width and the belt defines a belt width, the belt width being equal to or greater than the opening width.

17. The smoke generating assembly of claim 15, wherein the belt feeder further comprises:
a plurality of fins extending along a belt width of the belt and spaced apart along a length of the belt.

18. The smoke generating assembly of claim 15, wherein a clearance gap is defined between the bottom of the hopper and a top surface of the belt feeder, the clearance gap being sized such that the bottom of the hopper spreads the combustible material on the belt in a single layer.

19. The smoke generating assembly of claim 15, wherein the belt is angled downward toward the smoldering heater.

20. The smoke generating assembly of claim 15, wherein the smoke generating assembly further comprises:
a pellet regulation device positioned over the supply opening of the hopper for regulating distribution of the combustible material.
